(19) United States
(12) Patent Application Publication
(10) Pub. No.: US 2016/0369877 A1
(43) Pub. Date: Dec. 22, 2016

(54) NO-BACK BRAKE FUNCTIONALITY MONITOR

(71) Applicant: Moog Inc., East Aurora, NY (US)

(72) Inventors: Seth Gitnes, Snohomish, WA (US); Derek Pedersen, South Jordan, UT (US)

(21) Appl. No.: 14/741,512

(22) Filed: Jun. 17, 2015

(51) Int. Cl. F16H 25/24; G01L 3/14; B64C 13/28

(52) U.S. Cl. CPC F16H 25/2454; B64C 13/28; G01L 3/1464

(57) ABSTRACT

A no-back device usable in a Horizontal Stabilizer Trim Actuator (HSTA) includes a ratchet and pawl brake mechanism in which a pivot pin supporting the pawl includes a sensor for directly measuring torque developed by the brake mechanism. A signal generated by the sensor may be evaluated to determine the apparent operational integrity of the no-back device.

### FIELD OF THE INVENTION

The present invention relates generally to “no-back” brake mechanisms for braking unintended rotation of an actuator ball screw when the ball screw is subjected to an aiding load and allowing freewheeling rotation of the ball screw when the ball screw is subjected to an opposing load.

### BACKGROUND OF THE INVENTION

Ball screws are in common use today for a variety of applications. One such application is to control the displacement of an airfoil surface, such as a horizontal stabilizer on an aircraft. Horizontal Stabilizer Trim Actuators (HSTAs) are used to adjust the angle of the horizontal stabilizer on many aircraft. Due to the size and criticality of the horizontal stabilizer surface, a disconnect or runaway of the HSTA is potentially catastrophic for the aircraft. The aircraft can generally tolerate a jammed or fixed HSTA, provided it is a relatively infrequent event. In view of their criticality, HSTAs commonly have a primary load path and a separate secondary load path, in the event the primary load path fails. HSTAs also have primary and secondary brakes to ensure the actuator remains irreversible when it is not driving the horizontal stabilizer.

In such applications, a drive motor mounted on the aircraft is operated to selectively rotate a ball screw in an appropriate rotational direction, and a nut threadedly mounted on the ball screw is arranged to engage the airfoil surface at an eccentric location. Thus, the motor may selectively rotate the ball screw relative to the nut in one rotational direction to cause the airfoil surface to move or pivot in one direction, and may selectively rotate the ball screw in an opposite rotational direction relative to the nut to cause the airfoil surface to move or pivot in an opposite direction. The ball screw may be rotated relative to the nut, or the nut may be rotated relative to the ball screw, as desired.

The primary brakes on HSTAs are generally load-proportional skewed roller brakes that are energized by the axial load on the ball screw. The primary brakes, sometimes referred to as “no-back” devices, are used with ball screw actuator mechanisms such as HSTAs to provide a force that resists rotation of the ball screw in a direction that would result in movement of the airfoil surface in the direction of an applied aerodynamic force (i.e., an “aiding” load), and to apply little or no force resisting rotation of the ball screw in an opposite direction that would result in movement of the airfoil surface against the applied aerodynamic force (i.e., an “opposing” load).

One example of a no-back device is shown and described in U.S. Pat. No. 6,109,415. The no-back device disclosed in the '415 patent includes dual ratchet and pawl mechanisms mounted on the ball screw, wherein one of the mechanisms is active when an axial tension load is applied to the ball screw and the other mechanism is active when an axial compression load is applied to the ball screw. More specifically, the tension-activated mechanism resists rotation of the ball screw in a first rotational direction if the aerodynamic load is aiding airfoil adjustment to prevent the aerodynamic load from backdriving the ball screw, and allows substantially freewheeling rotation of the ball screw in a second rotational direction opposite the first rotational direction when the ball screw is driving against such aerodynamic load. Conversely, the compression-activated mechanism resists rotation of the ball screw in the second rotational direction if the aerodynamic load is aiding airfoil adjustment, and allows substantially freewheeling rotation of the ball screw in the first rotational direction when the ball screw is driving against such aerodynamic load. Thus, the no-back device disclosed in the '415 patent is a bidirectional device that resists ball screw rotation in the presence of an aiding aerodynamic load and allows substantially freewheeling rotation of the ball screw when an opposing aerodynamic load is present, regardless of the ball screw drive direction and the direction of aerodynamic loading.

In the device described in the '415 patent, each ratchet and pawl mechanism includes a ratchet wheel and two pawls arranged diametrically across from one another to engage the ratchet wheel and prevent rotation of the ratchet wheel. Two pawls are provided as a mechanical failsafe if one of the two pawls should experience failure. The tension-activated mechanism and the compression-activated mechanism include respective skewed roller brakes engaging the ratchet wheel of the mechanism for generating braking torque. The skew angle of the rollers and the mean radius of the rollers is carefully selected such that for a given axial load, the skewed roller always provides more braking torque than the ball screw generates as a result of the ball screw's lead (inches per revolution).

The apparent operational integrity of a primary no-back brake device has been difficult to check, but such checks are necessary because a latent (i.e. hidden) failure of the primary no-back device in combination with a later active failure of the secondary brake can result in a runaway HSTA, which can be catastrophic for the aircraft. On most current aircraft, inspection of the primary non-back braking device is a manually performed maintenance operation that must be performed by maintenance crew at set intervals. The inspection is often time consuming and costly for the aircraft operators. This drives the desire for an automated primary no-back monitoring function. U.S. Pat. No. 8,918,291 discloses a no-back monitor that monitors a differential pressure across hydraulic motors driving the HSTA to ascertain the functionality of the primary no-back brake, but this is very crude measurement due to variations in load, temperature and efficiency of the actuator and motors.

Aircraft applications typically require that the airfoil surface be placed in a slip stream by flying the aircraft before an “aiding” or “opposing” load may be applied to the ball screw. It would be generally desirable to be able to check the apparent operational integrity of a no-back device while the aircraft is on the ground and while the airfoil surface is unloaded. U.S. Pat. No. 8,646,726 discloses a method and apparatus for determining apparent operational integrity of an airfoil no-back device by adding one spring or a pair of springs to the no-back device for exerting an axial preload force simulating application of an external load on the ball screw. The approach disclosed in the '726 patent enables operational integrity to be checked while the aircraft is on the ground, but it relies on sensing current at the motor. Consequently, accuracy of the sensing is diminished by efficiency losses attributed to the motor and the gear train between the motor and the no-back mechanism. The solution offered by the '726 patent also adds weight to the no-back device.

It would be desirable to provide a system whereby the apparent operational integrity of a no-back brake device may be monitored and reported without time consuming manual inspections.

It would also be desirable to provide a system for determining the apparent operational integrity of a no-back brake device by direct measurement that is not affected by variations in temperature or efficiency of the motors or actuator.

In meeting the desires above, it would be advantageous to avoid additional weight and size in the no-back device as may result from the addition of further components.

### SUMMARY OF THE INVENTION

The present invention provides a no-back device for an actuator having a ball screw subject to an axially directed load, wherein the no-back device directly senses torque produced by the no-back device to allow the apparent operational integrity of the no-back device to be monitored and tested. The invention may be applied to an HSTA to allow operational integrity of the actuator's no-back device to be determined while the aircraft is on the ground and while it is in flight.

In one embodiment, the no-back device comprises a housing and a first brake mechanism. The housing is arranged to receive a portion of the ball screw, wherein the ball screw is mounted for rotation in first and second opposite rotational directions relative to the housing. The first brake mechanism is responsive when the axial load is in a first load direction. The first brake mechanism acts between the housing and the ball screw to produce a first torque resisting rotation of the ball screw in the first rotational direction and not substantially resisting rotation of the ball screw in the second rotational direction. The first brake mechanism includes a first ratchet wheel and a first pawl, wherein the first pawl is pivotally mounted to the housing by a first pivot pin and engages the first ratchet wheel to prevent rotation of the first ratchet wheel relative to the housing when the ball screw rotates in the first rotational direction. The first pawl permits rotation of the first ratchet wheel relative to the housing when the ball screw rotates in the second rotational direction. In accordance with the present invention, the first pivot pin supporting the first pawl includes a first sensor generating a signal representative of the first torque produced by the first brake mechanism. The sensor signal may be evaluated to assess the operational integrity of the no-back device.

The no-back device may be a bidirectional no-back device including a second brake mechanism oppositely configured relative to the first brake mechanism and having a second ratchet, pawl and sensing pivot pin for measuring a second torque produced by the second brake mechanism.

The invention is further embodied by a method for testing operational integrity of a no-back device having a brake mechanism configured to apply a torque resisting rotation of a ball screw in a braked rotational direction and not substantially resisting rotation of the ball screw in a freewheeling rotational direction opposite the braked rotational direction. The method generally comprises the steps of measuring the torque produced by the brake mechanism when the ball screw is rotated in the braked rotational direction using a sensor associated with a structural member of the brake mechanism, and evaluating a braking torque signal generated by the sensor to determine operational integrity of the no-back device. The method may further comprise the steps of measuring the torque produced by the brake mechanism when the ball screw is rotated in the freewheeling rotational direction using the sensor, and evaluating a freewheeling torque signal generated by the sensor to further determine operational integrity of the no-back device. The sensor signals may be evaluated by comparing the braking torque signal level to a minimum required braking torque threshold and by comparing the freewheeling torque signal level to a maximum allowed freewheeling torque threshold. The sensor signals may also be evaluated over time and correlated with electric current or hydraulic pressure supplied to a drive motor of the actuator to provide an indication of trends in performance of the no-back device to enable preventive maintenance before a failure occurs.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic view showing an actuator arranged to act between an airfoil surface and an aircraft fuselage, wherein the actuator incorporates a no-back device formed in accordance with an embodiment of the present invention;

FIG. 2 is a longitudinal cross-sectional view of a no-back device formed in accordance with an embodiment of the present invention;

FIG. 3 is a transverse cross-sectional view of the no-back device shown in FIG. 2 taken generally through a ratchet plate and pawl of a first brake mechanism of the no-back device;

FIG. 4 is an enlarged view of region A in FIG. 2; and

FIG. 5 is an enlarged, partially cross-sectioned view of a torque sensing pin used in a no-back device formed in accordance with an embodiment of the present invention.

### DETAILED DESCRIPTION OF THE INVENTION

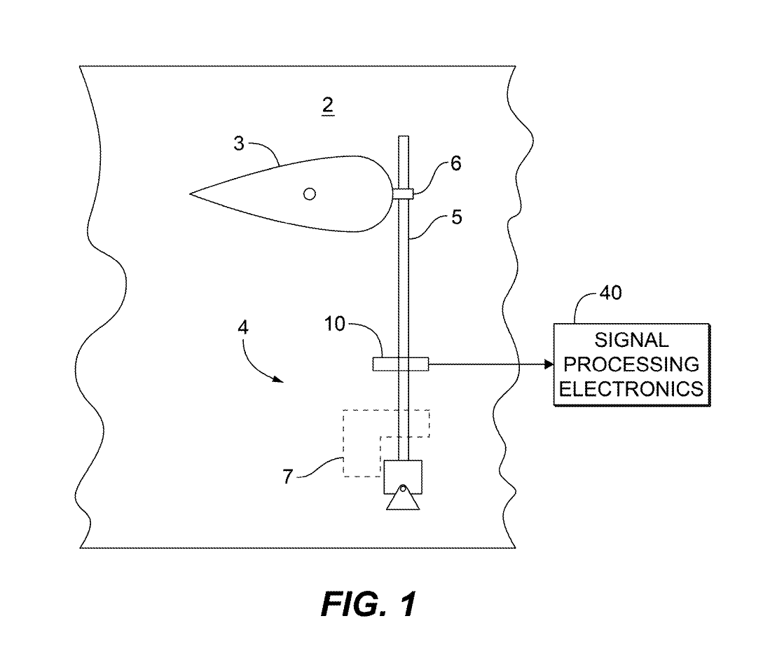

FIG. 1 shows an actuator 4 arranged to act between an airfoil surface 3 and a fuselage 2 of an aircraft to adjust the orientation of the airfoil surface relative to the fuselage. Actuator 4 includes ball screw 5 and a ball nut 6 mated with the ball screw. Actuator 4 further includes a motor 7 for driving relative rotation between ball screw 5 and ball nut 6 to cause axially-directed relative motion between the ball screw and the ball nut. By way of non-limiting example, motor 7 may be an electric motor or a hydraulic motor. Actuator 4 incorporates a no-back device 10 formed in accordance with an embodiment of the present invention. As will be understood from the representative embodiment described herein, no-back device 10 may be configured as a bidirectional no-back device suitable for use as a primary brake for an HSTA used to adjust the angle of an aircraft horizontal stabilizer.

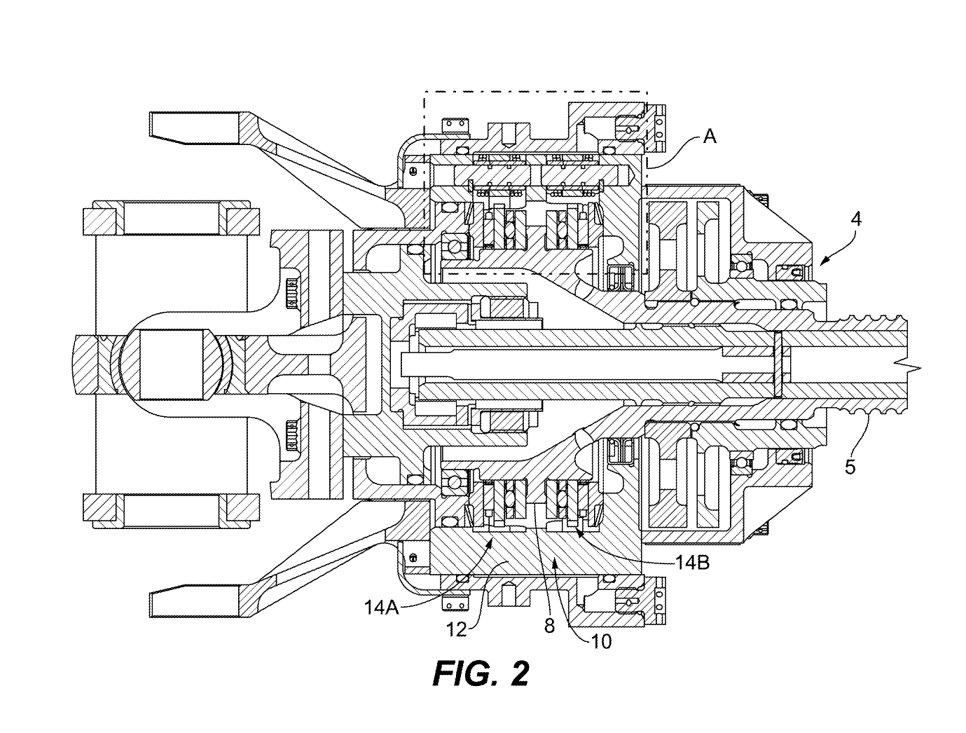

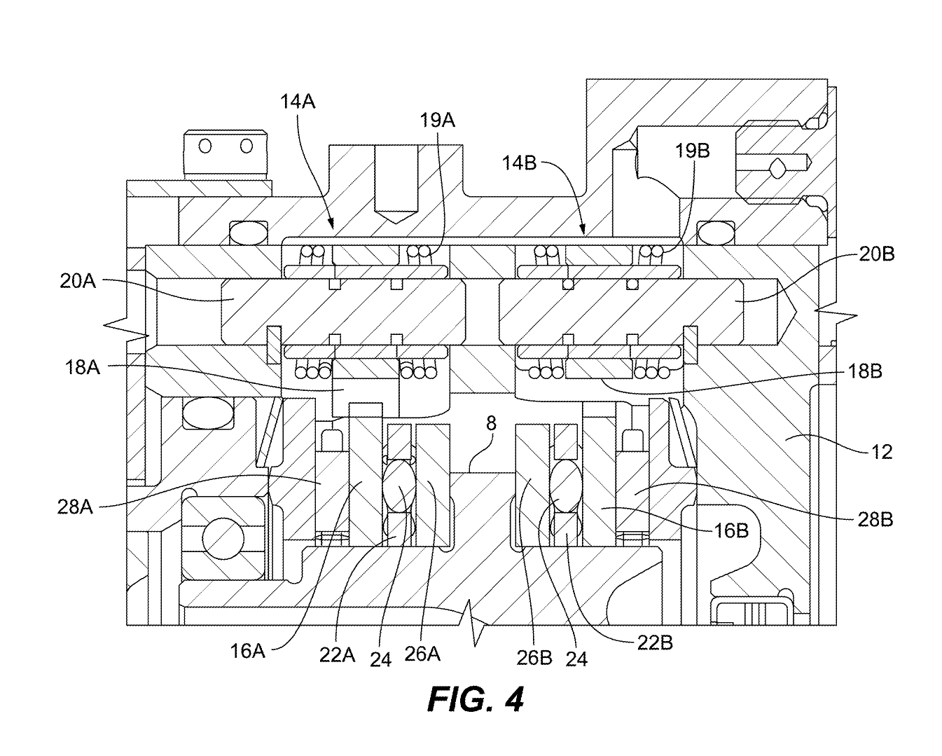

Reference is now made to FIGS. 2-4 showing no-back device 10 in greater detail. No-back device 10 comprises a housing 12 arranged to receive a portion of ball screw 5, wherein the ball screw is mounted for rotation about its axis relative to housing 12 in first and second opposite rotational directions. No-back device 10 also comprises a first brake mechanism, generally identified by reference numeral 14A, designed to act between housing 12 and ball screw 5 to produce a torque that resists rotation of ball screw 5 in the first rotational direction, but does not substantially resist rotation of ball screw 5 in the second (opposite) rotational direction. Thus, with respect to first brake mechanism 14A, the first rotational direction of ball screw 5 may be referred to as a “braked” rotational direction, and the second rotational direction of ball screw 5 may be referred to as a “freewheeling” rotational direction.

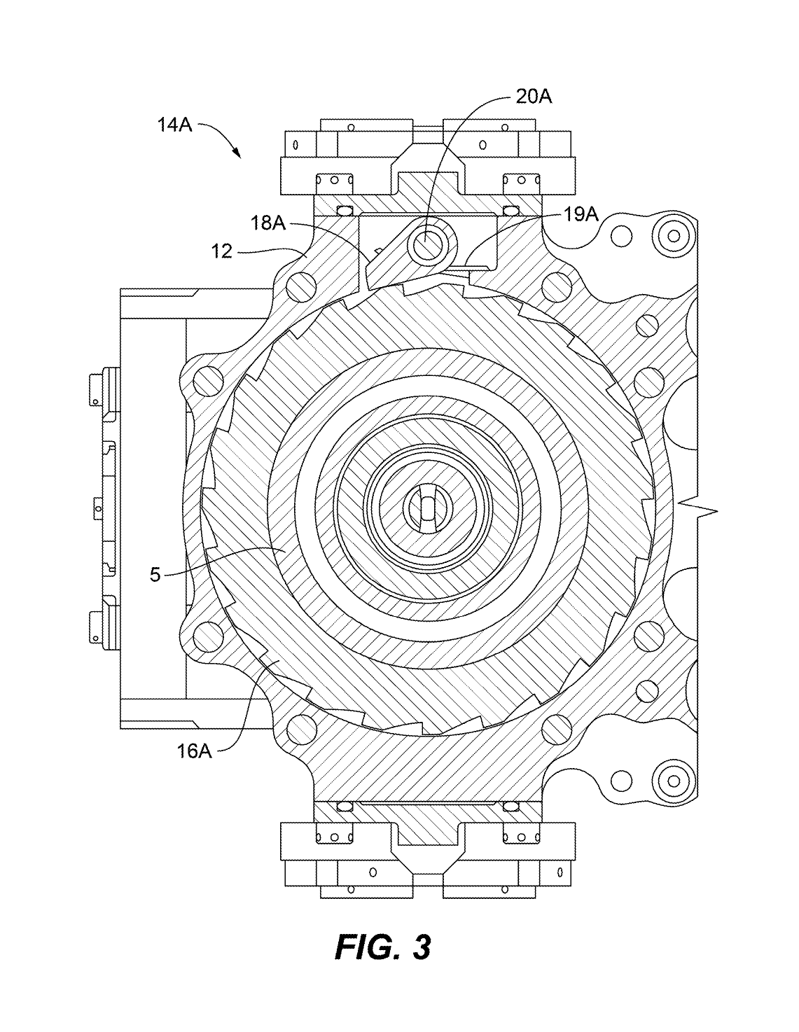

First brake mechanism 14A includes a ratchet wheel 16A and a cooperating pawl 18A. Ratchet wheel 16A is mounted coaxially on ball screw 5 so as to permit relative rotation between ratchet wheel 16A and ball screw 5 and slidable displacement of ratchet wheel 16A relative to ball screw 5 along the ball screw axis. Pawl 18A is pivotally mounted to housing 12 by a pivot pin 20A, and is spring-loaded by a torsion spring 19A to pivot about pivot pin 20A for engaging ratchet wheel 16A to prevent rotation of ratchet wheel 16A relative to housing 12 when ball screw 5 rotates in the first rotational direction (clockwise in FIG. 3) and to permit rotation of ratchet wheel 16A relative to housing 12 when ball screw 5 rotates in the second rotational direction (counterclockwise in FIG. 3).

First brake mechanism 14A may include a skewed roller plate 22A arranged on ball screw 5 adjacent ratchet wheel 16A. Like ratchet wheel 16A, skewed roller plate 22A is able to rotate relative to ball screw 5 and slide axially along the ball screw. Skewed roller plate 22A has a circular array of cylindrical rollers 24 each having a rotational axis skewed at an angle a relative to a diameter intersecting the center of the roller. The skew angle of rollers 24, the radius to the centers of the rollers, and the length of the rollers may be chosen to provide an effective coefficient of friction for the skewed roller plate 22A.

First brake mechanism 14A may include also include a pair of thrust washers 26A and 28A sandwiching ratchet wheel 16A and skewed roller plate 22A. In the depicted embodiment, thrust washers 26A and 28A are coupled to ball screw 5 by a keyway or spline to cause the thrust washers to rotate together with ball screw 5 and to allow the thrust washers to slide axially along ball screw 5.

No-back device 10 may include a second brake mechanism 14B designed to act between housing 12 and ball screw 5 to produce a torque that resists rotation of ball screw 5 in the second rotational direction, but does not substantially resist rotation of ball screw 5 in the first rotational direction. With respect to second brake mechanism 14B, the first rotational direction of ball screw 5 is a “freewheeling” rotational direction, and the second rotational direction of ball screw 5 is a “braked” rotational direction. Second brake mechanism 14B may be configured essentially as a mirror image of first brake mechanism 14A to operate in an opposite manner. Thus, second brake mechanism 14B may include a respective ratchet wheel 16B, pawl 18B, torsion spring 19B, pivot pin 20B, skewed roller plate 22B, and thrust washers 26B, 28B.

In the illustrated embodiment, first brake mechanism 14A and second brake mechanism 14B are located on opposite sides of a radial flange 8 on ball screw 5. As may be understood, first brake mechanism 14A is responsive when the axial load on ball screw 5 is in a compression load direction causing flange 8 to shift slightly to the left in FIG. 2. Conversely, second brake mechanism 14B is responsive when the axial load on ball screw 5 is in a tension load direction causing flange 8 to shift slightly to the right in FIG. 2. As flange 8 shifts in a given axial direction, a frictional a frictional torque is produced by contact with the associated ratchet wheel 16A or 16B. If ball screw 5 is rotating in a braked direction with respect to the responding brake mechanism 14A or 14B, substantial frictional torque is developed through the corresponding skewed roller plate 22A or 22B against the non-rotating ratchet wheel. If ball screw 5 is rotating in a freewheeling direction with respect to the responding brake mechanism 14A or 14B, insubstantial frictional torque is developed through the corresponding pawl 18A or 18B as the associated ratchet wheel 16A or 16B rotates with ball screw 5 and passes the torsionally-biased pawl.

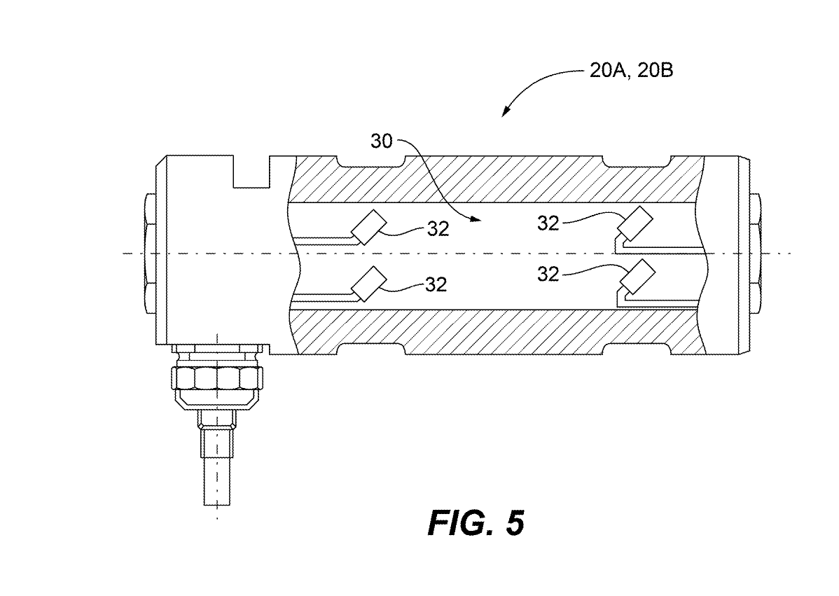

In accordance with the present invention, pivot pins 20A and 20B are embodied as load sensing pins to directly measure torque produced by first and second brake mechanisms 14A and 14B, respectively. As shown in FIG. 5, pivot pins 20A and 20B each include a respective sensor 30 generating a signal representative of the measured torque produced by the corresponding brake mechanism. For example, each sensor 30 may include a plurality of strain gauges 32 connected in a Wheatstone bridge circuit. Suitable load pins are commercially available from Measurement Specialties, Inc. of Fremont, Calif. under part family no. FN1010, and from SENSY S.A. of Belgium under part family no. 5000.

As shown in FIG. 1, analog torque signals from pivot pins 20A and 20B of no-back device 10 are communicated by wired or wireless connection to signal processing electronics 40. Signal processing electronics 40 may be configured to convert the analog torque signals to digital form, and may include a microprocessor programmed to evaluate the digitized torque signals. Alternatively, analog signal processing electronics may be used to evaluate the analog torque signals. As explained below, the torque signals may be evaluated to determine operational integrity of no-back device 10.

The step of evaluating a given torque signal will depend on whether ball screw 5 is rotating in the braked direction or the freewheeling direction with respect to the corresponding brake mechanism 14A or 14B. If ball screw 5 is rotating in the braked direction, signal evaluation may include comparing the signal level to a braking threshold value corresponding to a minimum required braking torque. If the comparison indicates that brake mechanism 14A or 14B is failing to produce the minimum required braking torque, as may occur if the associated pawl 18A or 18B suddenly fails, then further actions may be taken or commanded based on this result. Alternatively or in addition to a threshold comparison as described above, the braking torque signal level may be monitored over time and correlated with current supplied to motor 7 or with hydraulic pressure supplied to motor 7, as these motor input parameters are proportional to the load being driven. This type of evaluation will indicate if the braking performance of no-back device is diminishing, and will allow preventive maintenance to be performed before a catastrophic failure occurs.

If ball screw 5 is rotating in the freewheeling direction with respect to the corresponding brake mechanism 14A or 14B, then signal evaluation may include comparing the signal level to a freewheeling threshold value corresponding to a maximum allowed freewheeling torque. If the comparison indicates that brake mechanism 14A or 14B is producing unwanted torque when ball screw 5 is rotating in the freewheeling direction, as may occur if the associated pawl 18A or 18B or associated ratchet wheel 16A or 16B is jammed, then further actions may be taken or commanded based on this result. Alternatively or in addition to a freewheeling threshold comparison as described above, the freewheeling torque signal level may be monitored over time and correlated with current supplied to motor 7 or with hydraulic pressure supplied to motor 7. This type of evaluation will indicate if the freewheeling performance of no-back device 10 is degrading and unwanted torque is being produced, and will allow preventive maintenance to be performed to correct the problem.

In no-back devices of the prior art having a pawl and ratchet wheel mechanism, e.g. those described in U.S. Pat. Nos. 6,109,415 and 8,646,726, two diametrically opposite pawls have been used for stopping rotation of the ratchet wheel as a redundancy measure in case one of the pawls fails. The aircraft may fly with only one active pawl until discovery of the failure at the next scheduled manual inspection. In the embodiment described herein, exactly one pawl may be used because pawl failure is immediately signaled. Thus, the number of parts in the no-back device may be reduced along with the complexity of the device. Of course, more than one pawl may be used without straying from the invention.

The present invention avoids the use of additional structural components in the no-back device, for example extra axial biasing springs as used in U.S. Pat. No. 8,646,726, which add weight, cost, and complexity to the no-back device. Moreover, the present invention provides a direct measurement that is not influenced by variations in load, temperature and efficiency of the actuator and motors.

While the invention has been described in connection with exemplary embodiments, the detailed description is not intended to limit the scope of the invention to the particular forms set forth. The invention is intended to cover such alternatives, modifications and equivalents of the described embodiments as may be included within the scope of the invention.

What is claimed is:

1. A no-back device for an actuator having a ball screw subject to an axially directed load, the no-back device comprising:
a housing arranged to receive a portion of the ball screw, wherein the ball screw is mounted for rotation in first and second opposite rotational directions relative to the housing; and
a first brake mechanism responsive when the axial load is in a first load direction, the first brake mechanism acting between the housing and the ball screw to produce a first torque resisting rotation of the ball screw in the first rotational direction and not substantially resisting rotation of the ball screw in the second rotational direction, wherein the first brake mechanism includes a first ratchet wheel and a first pawl, the first pawl being pivotally mounted to the housing by a first pivot pin, wherein the first pawl engages the first ratchet wheel to prevent rotation of the first ratchet wheel relative to the housing when the ball screw rotates in the first rotational direction and the first pawl permits rotation of the first ratchet wheel relative to the housing when the ball screw rotates in the second rotational direction;
wherein the first pivot pin includes a first sensor generating a signal representative of the first torque produced by the first brake mechanism.

2. The no-back device of claim 1, wherein the first sensor includes at least one strain gauge embedded in the first pivot pin.

3. The no-back device of claim 1, further comprising signal processing electronics connected to the first sensor for evaluating the signal generated by the first sensor.

4. The no-back device of claim 1, wherein the first brake mechanism includes exactly one first pawl.

5. The no-back device of claim 1, further comprising:
a second brake mechanism responsive when the axial load is in a second load direction opposite the first load direction, the second brake mechanism acting between the housing and the ball screw to produce a second torque resisting rotation of the ball screw in the second rotational direction and not substantially resisting rotation of the ball screw in the first rotational direction, wherein the second brake mechanism includes a second ratchet wheel and a second pawl, the second pawl being pivotally mounted to the housing by a second pivot pin, wherein the second pawl engages the second ratchet wheel to prevent rotation of the second ratchet plate relative to the housing when the ball screw rotates in the second rotational direction and the second pawl permits rotation of the second ratchet wheel relative to the housing when the ball screw rotates in the first rotational direction;
wherein the second pivot pin includes a second sensor generating a signal representative of the second torque produced by the second brake mechanism.

6. The no-back device of claim 5, wherein the first load direction is a compression load and the second load direction is a tension load.

7. The no-back device of claim 5, wherein the first sensor includes at least one strain gauge embedded in the first pivot pin and the second sensor includes at least one strain gauge embedded in the second pivot pin.

8. The no-back device of claim 5, further comprising signal processing electronics connected to the first sensor and to the second sensor for evaluating the respective signals generated by the first and second sensors.

9. The no-back device of claim 5, wherein the first brake mechanism includes exactly one first pawl and the second brake mechanism includes exactly one second pawl.

10. A method for testing operational integrity of a no-back device having a brake mechanism configured to apply a torque resisting rotation of a ball screw in a braked rotational direction and not substantially resisting rotation of the ball screw in a freewheeling rotational direction opposite the braked rotational direction, the method comprising:
measuring the torque produced by the brake mechanism when the ball screw is rotated in the braked rotational direction, wherein the torque is measured using a sensor associated with a structural member of the brake mechanism, the sensor generating a braking torque signal representative of the torque produced by the brake mechanism when the ball screw is rotated in the braked rotational direction; and
evaluating the braking torque signal to determine operational integrity of the no-back device.

11. The method according to claim 10, wherein the step of evaluating the braking torque signal includes comparing the braking torque signal to a braking threshold value corresponding to a minimum required braking torque.

12. The method according to claim 10, wherein the ball screw is driven to rotate by a motor, and the step of evaluating the braking torque signal includes monitoring the braking torque signal over time and correlating the braking torque signal with electric current or hydraulic pressure supplied to energize the motor.

13. The method according to claim 10, wherein the method further comprises:
measuring the torque produced by the brake mechanism when the ball screw is rotated in the freewheeling rotational direction, wherein the torque is measured using the sensor, the sensor generating a freewheeling torque signal representative of the torque produced by the brake mechanism when the ball screw is rotated in the freewheeling rotational direction; and
evaluating the freewheeling torque signal to further determine operational integrity of the no-back device.

14. The method according to claim 13, wherein the step of evaluating the freewheeling torque signal includes comparing the freewheeling torque signal to a freewheeling threshold value corresponding to a maximum allowed freewheeling torque.

15. The method according to claim 13, wherein the ball screw is driven to rotate by a motor, and the step of evaluating the freewheeling torque signal includes monitoring the freewheeling torque signal over time and correlating the freewheeling torque signal with electric current or hydraulic pressure supplied to energize the motor.

16. The method according to claim 10, wherein the structural member of the brake mechanism is a pivot pin rotatably supporting a pawl of the brake mechanism.
